(19) United States
(12) Patent Application Publication
(10) Pub. No.: US 2023/0326437 A1
(43) Pub. Date: Oct. 12, 2023

(54) ELECTRONIC EQUIPMENT, DEVICE, SYSTEM, METHOD, AND PROGRAM

(71) Applicant: CASIO COMPUTER CO., LTD., Tokyo (JP)

(72) Inventors: Fuminori SANO, Tokyo (JP); Jun SATO, Tokyo (JP); Hiroki KANNO, Tokyo (JP)

(73) Assignee: CASIO COMPUTER CO., LTD., Tokyo (JP)

(21) Appl. No.: 18/210,267

(22) Filed: Jun. 15, 2023

Related U.S. Application Data
(63) Continuation of application No. PCT/JP2021/044057, filed on Dec. 1, 2021.

(30) Foreign Application Priority Data
Dec. 17, 2020 (JP) 2020-208919

(51) Int. Cl. G10H 1/00

(52) U.S. Cl. CPC G10H 1/0066; G10H 1/0083; G10H 2240/211; G10H 2240/311

(57) ABSTRACT

An electronic equipment according to an embodiment of the present disclosure includes: a reception circuit that receives a musical instrument digital interface (MIDI) message, time stamp information regarding an execution timing of the MIDI message, and offset information regarding buffering of the MIDI message; and a processor that controls the execution timing of the MIDI message according to the time stamp information on a basis of the offset information.

### CROSS-REFERENCE TO RELATED APPLICATIONS

This application is a continuation of International Patent Application No. PCT/JP2021/044057 filed on Dec. 1, 2021, and claims priority to Japanese Patent Application No. 2020-208919 filed on Dec. 17, 2020, the entire content of both of which is incorporated herein by reference.

### TECHNICAL FIELD

The present disclosure relates to an electronic equipment, a device, a system, a method, and a program using radio communication.

### BACKGROUND ART

Musical instrument digital interface (MIDI) is widely used as a format for exchanging data for playing an electronic musical instrument between equipment. On the other hand, in recent years, radio communication devices are actively used, and a technique of wirelessly transmitting and receiving MIDI has been studied. For example, MIDI over Bluetooth LE (or BLE MIDI) that transmits and receives MIDI using Bluetooth (registered trademark) Low Energy (Bluetooth LE) has been studied.

In addition, a dongle device that can implement BLE MIDI only by being inserted into a MIDI terminal of an existing electronic musical instrument has been proposed (Patent Literature 1).

### CITATION LIST

### Patent Literature

Patent Literature 1: JP 2015-179141 A

### SUMMARY OF INVENTION

It is therefore an object of the present disclosure to provide an electronic equipment, a device, a system, a method, and a program capable of implementing suitable adjustment of trade-off between jitter and latency.

### Solution to Problem

An electronic equipment according to an embodiment of the present disclosure includes: a reception circuit that receives a musical instrument digital interface (MIDI) message, time stamp information regarding an execution timing of the MIDI message, and offset information regarding buffering of the MIDI message; and a processor that controls the execution timing of the MIDI message according to the time stamp information on a basis of the offset information.

### Advantageous Effects of Invention

According to the embodiment of the present disclosure, it is possible to implement suitable adjustment of trade-off between jitter and latency.

### BRIEF DESCRIPTION OF DRAWINGS

FIG. 1 is a view illustrating an example of a schematic configuration of a system according to one embodiment.

FIG. 2 is a view illustrating an example of appearance of an electronic musical instrument 10 according to one embodiment.

FIG. 3 is a view illustrating an example of a hardware configuration of a control system 100 of the electronic musical instrument 10 according to one embodiment.

FIG. 4 is a view illustrating an example of a hardware configuration of a dongle 20 according to one embodiment.

FIG. 5 is a view illustrating an example of a hardware configuration of a device 30 according to one embodiment.

FIG. 6 is a sequence diagram of a jitter control method according to one embodiment.

FIGS. 7A to 7D are conceptual diagrams of correction based on a time stamp and an offset.

FIG. 8 is a sequence diagram of a radio performance measurement method according to one embodiment.

FIG. 9 is a view illustrating an example of a format of measurement data.

### DESCRIPTION OF EMBODIMENTS

Hereinafter, an embodiment of the present disclosure will be described in detail with reference to the accompanying drawings. In the following description, the same units are denoted by the same reference numerals. The same units have the same names, functions, and the like, and thus, detailed description thereof will not be repeated.

(System)

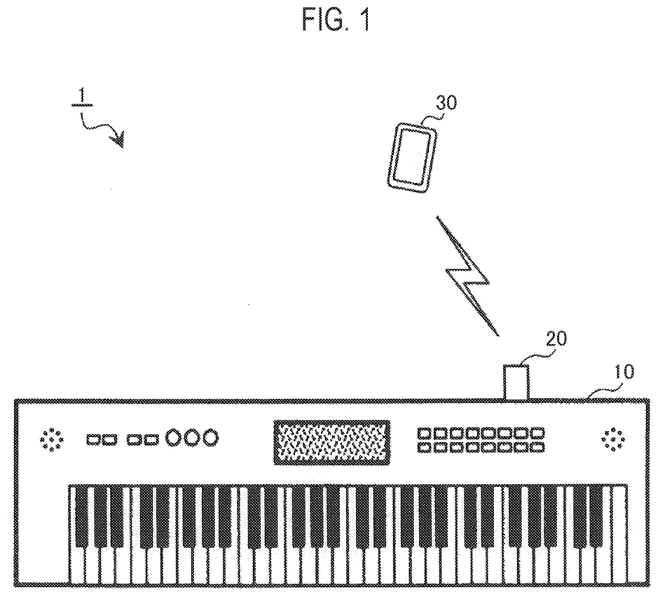

FIG. 1 is a view illustrating an example of a schematic configuration of a system according to one embodiment. The system 1 illustrated in FIG. 1 includes an electronic musical instrument 10, a dongle 20, and a device 30. The system 1 may be referred to as a MIDI transmission (or reproduction or execution) system, a radio performance assessment system, an electronic musical instrument system, or the like.

The electronic musical instrument 10 is an apparatus that receives an input from a user via an operator such as a keyboard and a switch and controls performance, or the like. The electronic musical instrument 10 may be an apparatus having a function of producing sound according to performance information such as MIDI data. The apparatus may be an electronic musical instrument (such as an electronic piano and a synthesizer), an analog musical instrument equipped with a sensor, or the like, and configured to have a function equivalent to that of the electronic musical instrument, or an electronic equipment (an electronic equipment similar to the device 30 to be described later) not having an operator (such as a keyboard) for performance. Note that, in the present disclosure, the electronic equipment may mean name including the electronic musical instrument 10 and other kinds of electronic equipment. In other words, in the present disclosure, the electronic musical instrument 10 may be read as the electronic equipment 10.

The dongle 20 is connected to the electronic musical instrument 10 and relays direct communication to and from the device 30. In the present disclosure, it is assumed that the dongle 20 is connected (mounted) to a universal serial bus (USB) terminal of the electronic musical instrument 10, but the present disclosure is not limited thereto. In a case where an interface other than the USB is used, the USB of the present disclosure may be implemented while the USB is read as the interface. The dongle 20 may be referred to as a communication apparatus for an electronic musical instrument.

The device 30 is an electronic equipment that performs communication with the electronic musical instrument 10 (or the dongle 20). The device 30 may be a mobile terminal (mobile communication terminal) such as a mobile phone, a smartphone and a tablet terminal or may be a fixed communication terminal such as a personal computer (PC), a server, a television and game machine. In other words, the device 30 in the present disclosure may be read as a communication device, a communication apparatus, a terminal apparatus, or the like.

<Electronic Musical Instrument>

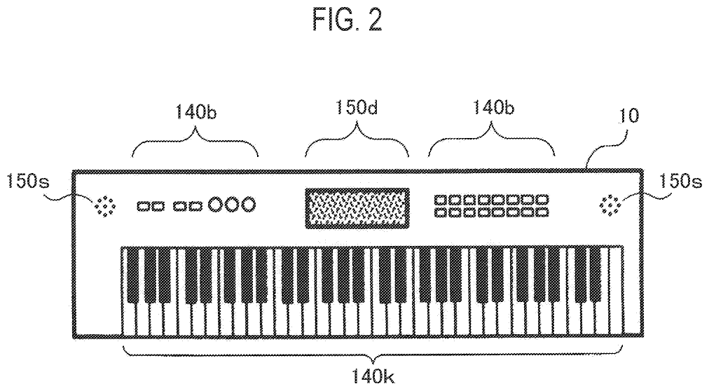

FIG. 2 is a view illustrating an example of appearance of the electronic musical instrument 10 according to one embodiment. The electronic musical instrument 10 may be equipped with a switch (button) panel 140b, a keyboard 140k, a display 150d, a speaker 150s, and the like.

The switch panel 140b may include switches for operating designation of volume, setting of a sound source, tone, and the like, selection of a song (accompaniment), start/stop of song reproduction, setting of song reproduction (tempo, and the like), and the like.

The keyboard 140k may have a plurality of keys as performance operators. The key may be referred to as a performance operator, a pitch operator, a tone operator, a direct operator, or the like.

The display 150d may display lyrics, music scores, various setting information, and the like. The speaker 150s may be used to emit sound generated by performance.

Note that the electronic musical instrument 10 may be able to generate and convert at least one of a MIDI message (event) or an open sound control (OSC) message. The “MIDI” of the present disclosure may be any of the MIDI 1.0 standard, the MIDI 2.0 standard, and a standard obtained by correcting/extending MIDI. In the present disclosure, the MIDI message and the MIDI data may be read as each other. Note that the MIDI message may mean a plurality of (for example, several bytes of) MIDI data that functions as one command.

The electronic musical instrument 10 may communicate with a network (such as the Internet) via at least one of wired or wireless (for example, long term evolution (LTE), 5th generation mobile communication system new radio (5G NR), Wi-Fi (registered trademark), Bluetooth, and the like).

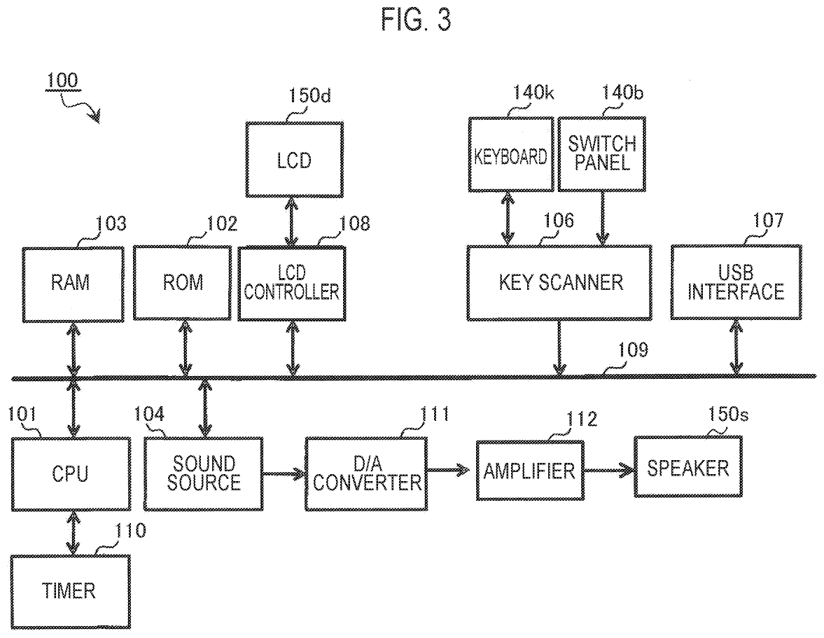

FIG. 3 is a view illustrating an example of a hardware configuration of the control system 100 of the electronic musical instrument 10 according to one embodiment.

A central processing unit (CPU) 101, a read only memory (ROM) 102, a random access memory (RAM) 103, a sound source 104, a key scanner 106 to which the switch (button) panel 140b and the keyboard 140k in FIG. 2 are connected, a USB interface 107, an LCD controller 108 to which a liquid crystal display (LCD) as an example of the display 150d in FIG. 2 is connected, and the like, are connected to a system bus 109.

A timer 110 (which may be referred to as a counter) for controlling performance may be connected to the CPU 101. The timer 110 may be used to count progress of automatic performance in the electronic musical instrument 10, for example. The CPU 101 may be referred to as a processor and may include an interface with a peripheral circuit, a control circuit, an operation circuit, a register, and the like.

The CPU 101 executes control operation of the electronic musical instrument 10 in FIG. 2 by executing a control program stored in the ROM 102 while using the RAM 103 as a work memory. In addition to the control program and various kinds of fixed data, the ROM 102 may store song data, accompaniment data, music (song) data including these, and the like.

The key scanner (scanner) 106 constantly scans a key depression/released state of the keyboard 140k in FIG. 2, a switch operation state of the switch panel 140b, and the like, and interrupts the CPU 101 to transmit a state change.

The LCD controller 108 is an integrated circuit (IC) that controls a display state of an LCD which is an example of the display 150d. The sound source 104 generates a digital sound source signal (for example, waveform data of musical instrument sound) corresponding to sound to be produced (note-on) on the basis of note-on/off data input from the CPU 101 on the basis of the key scanner 106 and outputs the digital sound source signal to a digital to analog (D/A) converter 111. The sound source 104 may execute processing such as envelope control of sound to be produced. The sound source 104 may execute sound synthesis processing to generate a signal of synthesized sound.

The D/A converter 111 converts the input digital signal into an analog signal and outputs the analog signal to an amplifier 112. The amplifier 112 may amplify the input signal and output the amplified signal from the speaker 150s or an output terminal (not illustrated).

The USB interface 107 exchanges a signal conforming to the USB standard with the dongle 20 physically connected to the electronic musical instrument 10 using an external connection terminal (for example, a connector). The USB interface 107 may include a USB connector (USB connection terminal).

In a case where the signal input from the USB interface 107 includes MIDI format data (MIDI data), the CPU 101 may perform reproduction processing using the sound source 104. In addition, the CPU 101 may generate MIDI data on the basis of key input information (for example, note on/off) acquired from the key scanner 106 and the like, output the MIDI data to the USB interface 107, and transmit the MIDI data to the device 30 via the dongle 20.

<Dongle>

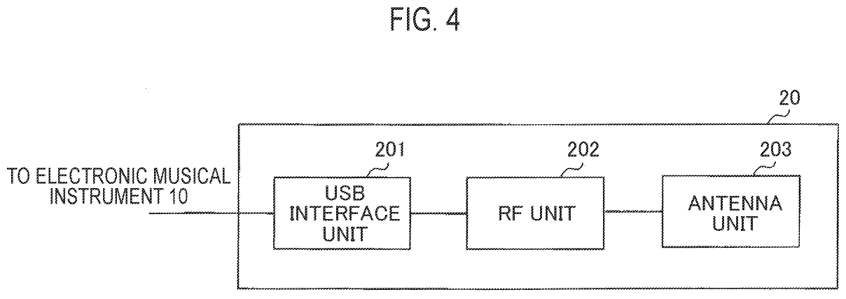

FIG. 4 is a view illustrating an example of a hardware configuration of the dongle 20 according to one embodiment. The dongle 20 includes, for example, a USB interface unit 201, an RF unit 202, an antenna unit 203, and the like. Note that it should be understood by those skilled in the art that each drawing of the present disclosure merely illustrates a configuration to be used for description and may include a configuration such as a power supply (not illustrated).

The USB interface unit 201 relays a signal (for example, a signal including MIDI data) conforming to the USB standard between the USB interface 107 of the electronic musical instrument 10 and the RF unit 202. In other words, the USB interface unit 201 has a function of bridging (converting) a signal to be used in the RF unit and a signal conforming to the USB standard.

For example, the USB interface unit 201 acquires original data from a signal (packet) transmitted via the USB interface 107 of the electronic musical instrument 10 and transfers the original data to the RF unit 202. Furthermore, the USB interface unit 201 includes the data transferred from the RF unit 202 in a USB packet and transmits the packet to the USB interface 107 of the electronic musical instrument 10.

The RF unit 202 implements transmission and reception of signals using radio communication (for example, Bluetooth, Wi-Fi, or the like).

The RF unit 202 may perform transmission processing such as channel encoding (which may include error correction encoding), modulation, mapping, filtering, inverse fast Fourier transform (IFFT), and digital-analog conversion on a bit string (for example, MIDI data) which is transferred from the USB interface unit 201 and which is to be transmitted, and output a baseband signal. The RF unit 202 may perform modulation to a radio frequency band, filtering, amplification, and the like, on the baseband signal and transmit the signal in the radio frequency band via an antenna unit 203.

On the other hand, the RF unit 202 may perform amplification, filtering, demodulation into a baseband signal, and the like, on the signal in the radio frequency band received by the antenna unit 203. The RF unit 202 may apply reception processing such as analog-digital conversion, fast Fourier transform (FFT) processing, filtering processing, demapping, demodulation, and decoding (which may include error correction decoding) to the acquired baseband signal, acquire transmitted data (for example, MIDI data) and transfer the acquired data to the USB interface unit 201.

Note that the RF unit 202 may simultaneously perform processing of converting the received radio signal into the transmitted data and processing of converting a bit string to be transmitted into a radio signal.

The antenna unit 203 can include at least one of antennas described on the basis of common recognition in the technical field according to the present disclosure, for example, a pattern antenna, a chip antenna, a dipole antenna, an omni antenna, a whip antenna, and the like.

In the present disclosure, other data (for example, audio data for musical accompaniment) may be transmitted and received through a USB interface or radio communication simultaneously with MIDI. Furthermore, the USB interface unit 201 of the present disclosure may be replaced with any interface unit that can be connected to and communicate with the electronic musical instrument 10. In this case, the “USB” of the present disclosure may be read as name related to an arbitrary interface unit, and “a signal conforming to the USB standard” may be read as a signal conforming to a standard to which the arbitrary interface unit conforms.

<Device>

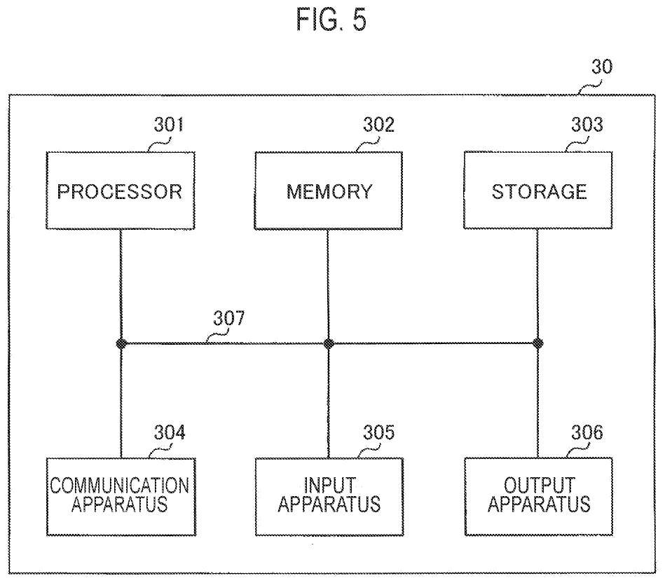

FIG. 5 is a view illustrating an example of a hardware configuration of the device 30 according to one embodiment. The device 30 may be physically configured as a computer apparatus including a processor 301, a memory 302, a storage 303, a communication apparatus 304, an input apparatus 305, an output apparatus 306, a bus 307, and the like.

The processor 301 performs operation by loading predetermined software (program) on hardware such as the processor 301 and the memory 302, and the functions of the device 30 are implemented by controlling communication by the communication apparatus 304, reading and/or writing of data in the memory 302 and the storage 303, and the like.

The processor 301 operates, for example, an operating system to control the entire computer. The processor 301 may be configured with a central processing unit (CPU) including an interface with a peripheral apparatus, a control apparatus, an operation apparatus, a register, and the like.

In addition, the processor 301 reads a program (program code), a software module, data, and the like, from at least one of the storage 303 and the communication apparatus 304 to the memory 302 and executes various kinds of processing according to the data. As the program, a program that causes a computer to execute at least part of the operation described in the embodiment of the present disclosure is used.

The memory 302 is a computer-readable recording medium and may include, for example, at least one of a read only memory (ROM), an erasable programmable ROM (EPROM), an electrically EPROM (EEPROM), a random access memory (RAM), or another appropriate storage medium. The memory 302 may be referred to as a register, a cache, a main memory (main storage device), or the like. The memory 302 may store a program (program code), a software module, and the like, that can be executed to implement the method according to one embodiment.

The storage 303 is a computer-readable recording medium and may be configured with, for example, at least one of a flexible disk, a floppy disk (registered trademark), a magneto-optical disk (for example, a compact disc (such as a compact disc ROM (CD-ROM)), a digital versatile disc, or a Blu-ray (registered trademark) disc), a removable disk, a hard disk drive, a smart card, a flash memory device (for example, a card, a stick, or a key drive), a magnetic stripe, a database, a server, or another appropriate storage medium. The storage 303 may be referred to as an auxiliary storage apparatus.

The communication apparatus 304 is hardware (transmission/reception device) for performing communication between computers via at least one of a wired network or a radio network and is also referred to as, for example, a network device, a network controller, a network card, a communication module, or the like.

The input apparatus 305 is an input device (for example, a keyboard, a mouse, and the like) that receives an input from the outside. The output apparatus 306 is an output device (for example, a display, a speaker, and the like) that performs output to the outside. Note that the input apparatus 305 and the output apparatus 306 may be integrated (for example, a touch panel).

In addition, the respective apparatuses such as the processor 301 and the memory 302 are connected by a bus 307 for communicating information. The bus 307 may be configured with a single bus or may be configured with different buses between apparatuses.

Note that these system configuration and equipment configuration are merely examples, and the present disclosure is not limited thereto. For example, the number of circuits included is not limited thereto. Each apparatus may have a configuration not including some circuits (mechanisms) or may have a configuration in which a function of one circuit is implemented by a plurality of circuits. Each apparatus may have a configuration in which functions of a plurality of circuits are implemented by one circuit.

Furthermore, the electronic musical instrument 10, the dongle 20, and the device 30 may include hardware such as a microprocessor, a digital signal processor (DSP), an application specific integrated circuit (ASIC), a programmable logic device (PLD), and a field programmable gate array (FPGA), and some or all of the functional blocks may be implemented by the hardware. For example, the CPU 101 may be implemented by at least one of these pieces of hardware.

Note that the block diagrams described above illustrate blocks of functional units. These functional blocks (components) are implemented by an arbitrary combination of hardware and/or software. In addition, means for implementing each functional block is not particularly limited. In other words, each functional block may be implemented by one physically coupled apparatus or may be implemented by a plurality of apparatuses in which two or more physically separated apparatuses are connected in a wired or wireless manner.

For example, although only one processor 301 is illustrated, there may be a plurality of processors. Furthermore, the processing may be executed by one processor, or the processing may be executed simultaneously, sequentially, or by two or more processors using other methods. Note that each functional block may be implemented by one or more chips.

(Latency and Jitter Control Method)

A latency and jitter control method according to one embodiment of the present disclosure will be described below.

There is a trade-off relationship between latency and jitter. The present inventors have found that while data control is performed on the reception side (electronic musical instrument 10 side), most of optimum setting values of a reception side buffer depends on the transmission side, such as how MIDI data is handled in application software on the transmission side (device 30 side), a data configuration of the MIDI data, and performance of the device 30.

Thus, the present inventors have conceived a control method in which application software of the device 30 can remotely set an optimal offset value for a time stamp control method and buffering of the electronic musical instrument 10 to the electronic musical instrument 10 in real time by using a message extendable/settable by a manufacturer in the MIDI data format. According to this configuration, balance between jitter and latency can be optimized. Furthermore, the application software of the device 30 can adjust optimum balance between latency and jitter without the user's consciousness.

Note that, although the present embodiment discloses a method using a system exclusive message as an extendable message, a non registered parameter number (NRPN) included in a control change message or an assignable controller message of the MIDI 2.0 standard may be used. In other words, the system exclusive message in the present disclosure may be read as a control change message, an NRPN, an assignable controller message, or the like.

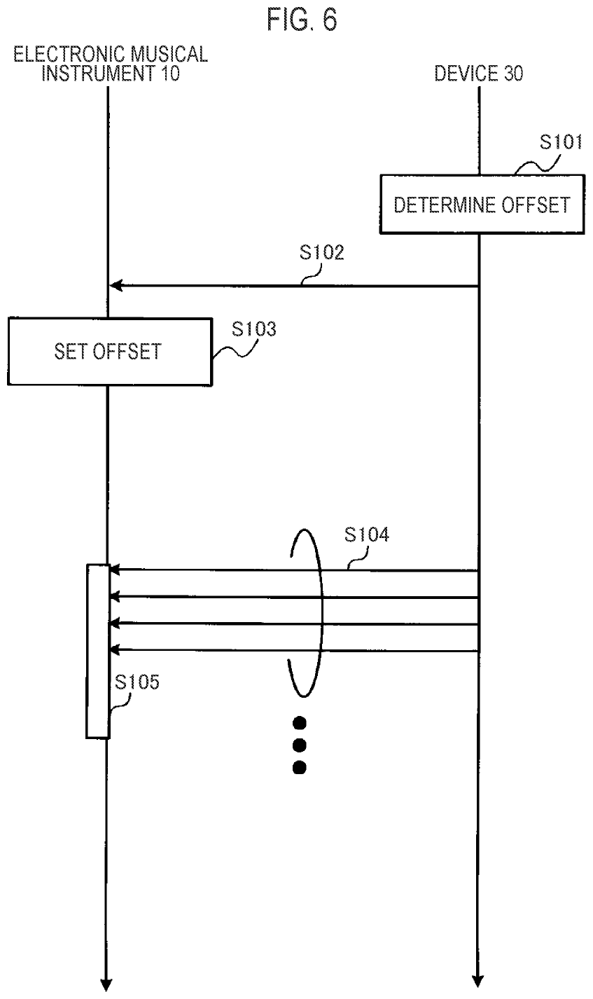

FIG. 6 is a view illustrating an example of a flowchart of a jitter control method according to one embodiment. In the description of the present disclosure, the device 30 may be read as an “application of the device 30”.

The device 30 determines an offset time related to buffering of the MIDI data (step S101). The device 30 may set a preset value as the offset time, may set a value input from the user as the offset time or may determine the offset time on the basis of measurement described later. For example, in a case where the device 30 determines that the jitter (or delay) between the device 30 and the electronic musical instrument 10 is relatively small (or almost 0) on the basis of the measurement, the device 30 may determine a relatively small value (or 0) as the offset time.

Note that the offset time may be read as an offset amount, an offset, or the like. Hereinafter, the offset time will be simply referred to as an offset. The offset may be referred to as a period related to buffering of MIDI data.

Furthermore, in step S101, the device 30 may determine whether or not to perform time stamp processing on the electronic musical instrument 10. For example, in a case where it is determined that the jitter (or delay) between the device 30 and the electronic musical instrument 10 is relatively small (or almost 0) on the basis of the measurement, the device 30 may determine to apply the timestamp processing, and otherwise, may determine not to apply the timestamp processing.

The device 30 transmits information about the determined offset to the electronic musical instrument 10 (step S102). The information about the offset (which may be referred to as offset information) may explicitly indicate the offset time itself (for example, 15 ms, 30 ms, or the like) or may indicate an index value associated with the offset time. A correspondence relationship between the index value and the offset time may be defined in advance or may be set. The correspondence relationship may indicate, for example, the offset time=0 (or no timestamp processing) for the index=0, the offset time=15 ms for the index=1, and the like.

The electronic musical instrument 10 sets the offset on the basis of the received offset information (step S103). Note that, in a case where the electronic musical instrument 10 does not receive the offset information, the electronic musical instrument 10 may determine that the offset is a predetermined value (default value, for example, 0).

The device 30 then transmits the MIDI data to the electronic musical instrument 10 via radio communication (for example, using BLE) (step S104). The electronic musical instrument 10 buffers the received MIDI data on the basis of the offset set in step S103 and performs execution (for example, reproduction, sound production) processing of the MIDI data (step S105). The execution processing in step S105 may include, for example, processing related to arbitrary MIDI data such as processing of a note-on message for starting sound production, processing of a note-off message for ending sound production, and processing of a message for turning on/off a pedal.

Note that, in step S102, information regarding the presence or absence of time stamp processing (which may be referred to as time stamp processing information) may be transmitted instead of or together with the offset information.

In BLE-MIDI or MIDI 2.0, a time stamp (time information) may be given when original MIDI data is transmitted. In a case where the time stamp processing information indicates “yes”, the electronic musical instrument 10 performs correction based on the time stamp in the execution processing in step S105. Otherwise, even if the time stamp is given to the received MIDI data, the electronic musical instrument 10 does not perform correction based on the time stamp (performs the execution processing while ignoring the time stamp).

The time stamp may be referred to as information on an execution timing of the MIDI message. In the present disclosure, the time stamp and the time stamp information may be read as each other. Note that the time stamp may be included in the MIDI data, or the electronic musical instrument 10 may be notified separately from the MIDI data. In the latter case, even in a case where MIDI 1.0 data whose time stamp information is not included in the standard is received, time stamp control can be applied on the basis of the present disclosure.

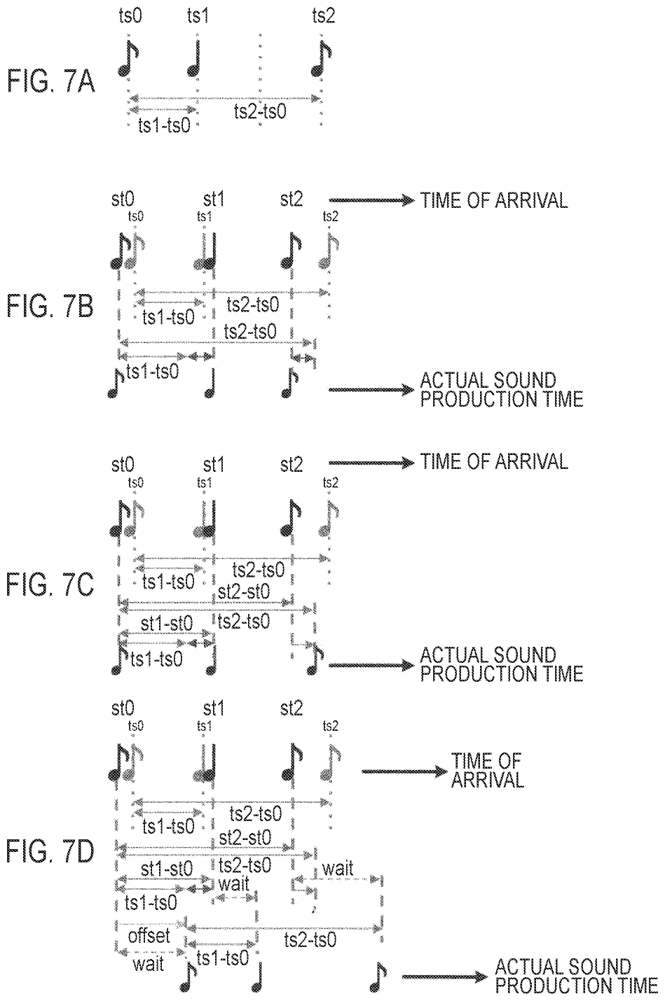

FIGS. 7A to 7D are conceptual diagrams of correction based on the time stamp and the offset.

FIG. 7A illustrates an example of a sound production timing as the original performance. In the figure, notes are arranged in the order of a note 0 having a length of an eighth note, a note 1 having a length of a fourth note, and a note 2 having a length of an eighth note. ts0, ts1, and ts2 correspond to time stamps indicating sound production times of the note 0, the note 1, and the note 2, respectively. The note 1 indicates that the sound has been produced at a time after ts1−ts0 from the note 0, and the note 2 indicates that the sound has been produced at a time after ts2−ts0 from the note 0.

FIGS. 7B to 7D illustrate sound production timings in a case where the data of FIG. 7A is transmitted and jitter occurs. Each of st0, st1, and st2 in an upper part of each figure indicates the time of arrival of the notes 0 to 2 at the reception side. Each timing is affected by the jitter, and st1−st0≠ts1−ts0 and st2 st0≠ts2−ts0. In addition, a position of the note described in a lower part of each figure indicates actual sound production time.

FIG. 7B illustrates an example of a sound production timing in a case where correction based on the time stamp is not performed. In this case, sound of each note is produced at the time of arrival, and thus, intervals of the sound production timings of the notes 0 to 2 are not maintained at ts0, ts1, and ts2.

FIG. 7C illustrates an example of the sound production timing in a case where correction based on the time stamp is performed without applying the offset. In this case, the sound production timing of the note that has arrived earlier than a reference is corrected. This reference may be, for example, a sound production timing based on a time stamp based on time of arrival of a certain note, or a sound production timing based on a time stamp based on certain time (for example, start time of a song or performance (such as MIDI reproduction)).

In the case of FIG. 7C, a difference (st2−st0) in the time of arrival based on the note 0 is smaller than a difference (ts2−ts0) in the time stamps (that is, the note 2 arrived earlier than the timing at which the sound is scheduled to be produced), and thus, the note 2 is corrected to the original sound production timing (the sound production timing is adjusted to a timing after ts2
ts0 from st0).

On the other hand, a difference (st1−st0) in the time of arrival with respect to the note 0 is larger than a difference (ts1−ts0) in the time stamps (that is, the note 1 arrived later than the timing at which the sound is scheduled to be produced), and thus, the note 1 cannot be corrected, and the sound is produced immediately after arrival.

In the case of FIG. 7C, the intervals of ts0, ts1, and ts2 are not maintained for the sound production timings of some notes.

FIG. 7D illustrates an example of the sound production timing in a case where the correction based on the time stamp is performed while the offset is applied.

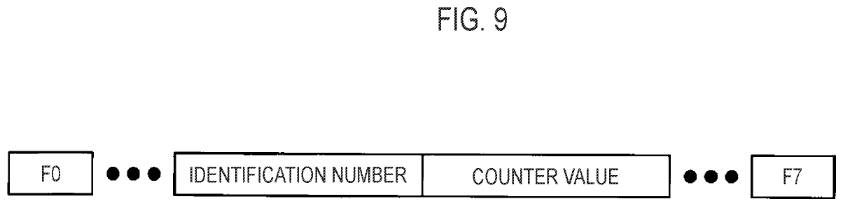

In this case, the sound production timing of the note that has arrived earlier than a reference is corrected. In addition, the sound production timing of the note that has arrived with a delay within the offset with respect to the reference is corrected. Similarly to FIG. 9C, the reference may be a sound production timing based on a time stamp based on the time of arrival of a certain note, or may be a sound production timing based on a time stamp based on certain time (for example, start time of a song or performance (such as MIDI reproduction)).

In the case of FIG. 7D, sound of the note 0 is produced after a period of an offset has elapsed since the time of arrival at st0. The note 1 arrives at st1, but the sound is not produced immediately and is produced after a period corresponding to a time stamp difference (ts1−ts0) has elapsed since the sound production timing of the note 0. The note 2 arrives at st2, but the sound is not produced immediately and is produced after a period corresponding to a time stamp difference (ts2−ts0) has elapsed since the sound production timing of the note 0.

In the case of FIG. 7D, intervals of ts0, ts1, and ts2 are maintained for the sound production timings of the notes.

<Format of Offset Information and Time Stamp Processing Information>

The electronic musical instrument 10 may be notified of at least one of the offset information or the time stamp processing information transmitted in step S102 described above using a system exclusive (SysEx) message of MIDI, a non registered parameter number (NRPN) included in a control change message, or the like.

The notifications of both the offset information and the timestamp processing information may be made in one SysEx message (or NRPN), or the notifications of the offset information and the timestamp processing information may be made separately in a plurality of SysEx messages (or NRPN).

In a case where the notification of the offset information is made by the SysEx message, the SysEx message may include information (bit string) indicating that the offset information is included and information (bit string) indicating content (for example, the offset time itself) of the offset information.

In a case where the notification of the time stamp processing information is made by the SysEx message, the SysEx message may include information (bit string) indicating that the time stamp processing information is included and information (bit string) indicating content (for example, time stamp processing is/is not performed) of the time stamp processing information.

The notifications of these pieces of information may be made using, for example, MIDI data bytes (for example, data bytes in a SysEx message). Note that in the present disclosure, in a case where a notification of arbitrary information is made using MIDI data bytes, the information needs to be configured in consideration of a fact that the most significant bit (MSB) of the data byte is 0. In other words, the device 30 on the transmission side transmits the information by allocating the information to respective data bytes in units of 7 bits, and the electronic musical instrument 10 on the reception side excludes MSBs of the respective data bytes of the received information and combines the data bytes to obtain the original information.

For example, in a case where the offset information to be transmitted is two bytes and is “0000000011111111”, the device 30 first divides every seven bits to obtain three bit strings of “0000000”, “0111111”, and “11”. Then, the device 30 may add ‘0’ (or in a case where the bit string is less than 1 byte, apply bit padding) to the beginning of each bit string to obtain three data bytes of “00000000”, “00111111”, and “01100000” and transmit the SysEx message including the three data bytes.

Note that the number of bits of the offset information/timestamp processing information for which the notification is made may be defined in advance or the device 30 may make a notification of the number. For example, the offset information may be expressed with 4, 8, 16, 32 bits, or the like, and the time stamp processing information may be expressed with 1 bit.

In a case where the notification of the offset information is made by the NRPN allocated to the control numbers 98 and 99 of the control change message, numerical values indicating the offset information may be set in the MSB and the LSB of the NRPN (may be arbitrarily set by the manufacturer), and the content of the offset information (for example, the offset time itself) may be set in a data entry of the NRPN and transmitted. The time stamp processing information may be similarly transmitted by the NRPN. The offset information or time stamp processing information may be transmitted by an assignable controller message newly defined as a message corresponding to the NRPN in MIDI 2.0.

(Radio Performance Measurement Method)

Depending on an environment around the electronic musical instrument 10 and the device 30, the radio communication quality between them fluctuates, which may affect jitter and latency. For this reason, it is preferable to easily measure performance of the radio between the electronic musical instrument 10 and the device 30 in real time.

The present inventors have conceived a data format and measurement method for this purpose.

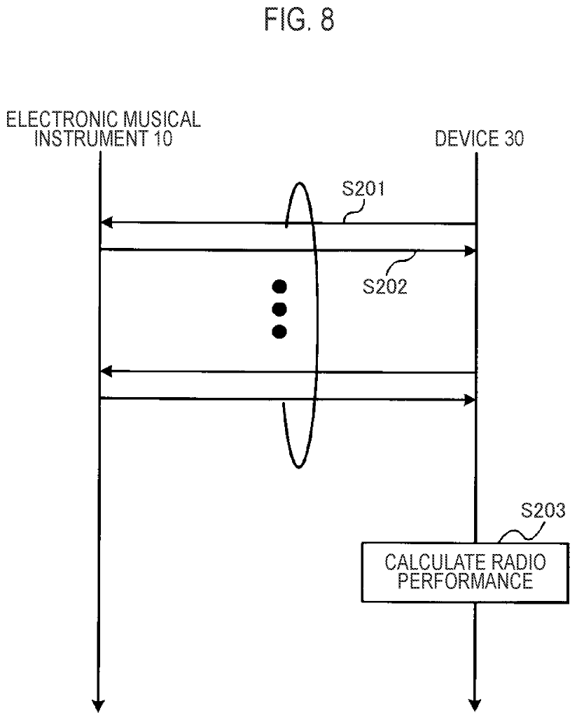

FIG. 8 is a sequence diagram of a radio performance measurement method according to one embodiment.

The device 30 transmits measurement data to the electronic musical instrument 10 (step S201). The transmission in step S201 may be a single time of transmission or a plurality of times of transmission at a certain transmission interval (for example, 7.5 ms, 15 ms, or the like) over a certain period (for example, is).

The electronic musical instrument 10 corrects a counter value for each piece of the received measurement data and returns the corrected counter value to the device 30 (step S202). The corrected measurement data may be referred to as return data, reply data, report data, or the like.

The device 30 calculates radio performance between the electronic musical instrument 10 and the device 30 on the basis of a transmission data amount of the measurement data in step S201, transmission time, reception time of the returned data in step S202, and the like (step S203). The radio performance may correspond to, for example, at least one of a throughput per unit time, a round-trip delay period, or the like.

In the present example, the device 30 has been described as the transmission side, and the electronic musical instrument 10 has been described as the reception side. However, the electronic musical instrument 10 may be the transmission side, and the device 30 may be the reception side.

Note that, before step S201, information making a notification of start of measurement may be transmitted from one of the device 30 and the electronic musical instrument 10 to the other. The device 30 and the electronic musical instrument 10 may reset an identification number, a counter value, and the like, to be described later, or achieve time synchronization (time adjustment), or the like, in response to the transmission and reception of the information.

In addition, the number of times of transmission (the number of pieces of transmission data), a transmission interval, a transmission period (measurement period), and the like, of the measurement data may be defined in advance in the device 30, or may be determined by the device 30 on the basis of an input from the user. The electronic musical instrument 10 may be notified of the information regarding the number of times of transmission, the transmission interval, the transmission period, and the like, of the measurement data from the device 30.

At the time of this measurement, the device 30 may simultaneously measure a received signal strength indicator (RSSI). The RSSI may be an instantaneous RSSI or an average/minimum/maximum RSSI in a certain period.

<Format of Measurement Data/Reply Data>

The electronic musical instrument 10 may be notified of the measurement data transmitted in step S201 described above by using at least one of a SysEx message, a control change message, or the like, of MIDI.

FIG. 9 is a view illustrating an example of a format of the measurement data. The format of this example corresponds to a SysEx message and starts with “F0” indicating start of the SysEx message and ends with “F7” indicating end of the SysEx message. Other information necessary for the SysEx message will not be described.

In a case where the notification of the measurement data is made by the SysEx message, the SysEx message may include information (bit string) of an identification number indicating an order number of the data and information (bit string) of a counter value indicating a value of a certain counter.

The notifications of these pieces of information may be made using, for example, MIDI data bytes (for example, data bytes in a SysEx message).

For example, the identification number information and the counter value information may be expressed with 4, 8, 16, 32 bits, or the like.

In step S201, in a case where the i-th (i is an integer) measurement data is transmitted among consecutive N pieces of measurement data (N is an integer), the device 30 sets, for example, a value of i−1 as the identification number information and transmits the information. In other words, for one time of measurement, the identification number starts from 0, and the device 30 sets and transmits a value obtained by counting up the value for each data. In other words, the identification number may mean “the number of times of transmission of the measurement data−1”. Further, in a case where arbitrary measurement data is transmitted, the device 30 sets an arbitrary value (for example, 0) as the counter value and transmits the data.

In step S202, the electronic musical instrument 10 increments its own counter value by +1 each time the measurement data is received. Note that the electronic musical instrument 10 may set the counter value to −1 at the start of measurement. In other words, the counter value of the electronic musical instrument 10 may mean “the number of times of reception of the measurement data −1”.

Furthermore, in step S202, the electronic musical instrument 10 may leave the identification number information of the received measurement data as it is, may set (update) its own counter value to the counter value information and return the counter value information to the device 30 as return data.

In other words, the formats of the measurement data and the reply data may be the same. In order to suppress influence of a difference in a data size on communication (improve measurement accuracy), sizes (bit numbers) of the measurement data and the reply data are preferably the same.

If the identification number and the counter value match in the received return data, the device 30 can determine that the measurement data transmitted so far has no loss (has been correctly transmitted and received).

The device 30 may derive a round-trip delay period (round trip time (RTT)) between the device 30 and the electronic musical instrument 10 on the basis of transmission time of the measurement data having the same identification number and reception time of the return data. Furthermore, the device 30 may derive a communication throughput between the device 30 and the electronic musical instrument 10 on the basis of a communication amount of the measurement data/return data per unit time. The RTT and the communication throughput may be instantaneous values or average/maximum/minimum values in a certain period.

Furthermore, the reception side (electronic musical instrument 10) may record deviation of the measurement data transmitted at equal intervals and calculate the jitter related to the transmission from the device 30 to the electronic musical instrument 10 on the basis of the deviation. The electronic musical instrument 10 may transmit the calculated jitter to the device 30. The electronic musical instrument 10 may transmit information regarding the jitter using a SysEx message.

In step S202, the electronic musical instrument 10 may leave the identification number information of the received measurement data as it is, set information regarding the reception time instead of the counter value information, and return the information to the device 30 as the return data. The information regarding the reception time has preferably the same number of bits (size) as the counter value information. The device 30 may calculate the jitter from the received return data.

Note that the electronic musical instrument 10 may return the return data including the counter value information and the information regarding the reception time to the device 30. The electronic musical instrument 10 may return, to the device 30, the return data including the identification number information, the counter value information, and the information regarding the reception time.

According to the measurement method as described above, for example, radio performance can be easily measured also in a case where other traffic (such as audio data) other than MIDI flows simultaneously with MIDI between the electronic musical instrument 10 and the device 30, and thus, jitter and latency in various environments can be suitably controlled.

(Modifications)

In each of the embodiments described above, the dongle 20 may be omitted. In this case, the electronic musical instrument 10 may have a function of performing radio communication with the device 30 (for example, the RF unit 202 and the antenna unit 203 in FIG. 4).

In each of the above-described embodiments (in particular, FIGS. 6, 8, and the like), the operation of the electronic musical instrument 10 may be performed by the dongle 20. For example, the offset in step S103 of FIG. 6 may be set at the dongle 20, and in this case, the buffering in step S105 may be performed by the dongle 20, and the electronic musical instrument 10 may receive MIDI buffered by the dongle 20 by an amount corresponding to an offset time and immediately perform the execution processing of the MIDI data.

Further, the return data in step S202 of FIG. 8 may be transmitted by the dongle 20. In this case, it is expected that performance of only a radio portion can be measured more precisely.

In each of the above-described embodiments (in particular, FIGS. 6, 8, and the like), the operation of the electronic musical instrument 10 may be performed by the dongle 20. For example, the offset in step S103 of FIG. 6 may be set at the dongle 20, and in this case, the buffering in step S105 may be performed by the dongle 20, and the electronic musical instrument 10 may receive MIDI buffered by the dongle 20 by an amount corresponding to an offset time and immediately perform the execution processing of the MIDI data.

In the above-described embodiment, an example in which the electronic musical instrument 10 is a keyboard musical instrument such as a keyboard has been described, but the present disclosure is not limited thereto. The electronic musical instrument 10 may be any instrument as long as it has a configuration in which the sound production timing can be designated by a user's operation, and may be an electric violin, an electric guitar, a drum, a trumpet, or the like.

Furthermore, the electronic musical instrument 10 is not limited to a so-called musical instrument (keyboard, or the like) and may be read as a mobile phone, a smartphone, a tablet terminal, a personal computer (PC), a television, or the like.

MIDI data itself does not have time-related data, and thus, a timing at which an instrument receives the MIDI data is a timing of controlling the instrument (such as sound production).

However, in a poor radio communication environment (for example, poor communication quality), a period until transmitted data arrives may vary. In Bluetooth LE, data communication is intermittently performed for the purpose of reducing power consumption. It is recommended that a timing difference between a plurality of intermittent transmissions be 15 ms (milliseconds) or less, and thus, there is a possibility that a data delay (fluctuation) of 15 ms may occur even in a good radio environment.

In BLE MIDI and MIDI 2.0, time stamps can be utilized, and if synchronization can be achieved using the time stamps, fluctuation (jitter) is improved regardless of a timing of reception. However, in order to obtain a sufficient improvement effect, it is necessary to increase a data buffer amount of a reception equipment, but in this case, there is a problem that a quantitative delay (latency) increases and real-time property is impaired. If trade-off between the jitter and the latency is not achieved well, quality of experience of a user is deteriorated.

On the other hand, in the invention, by using the electronic musical instrument 10, the dongle 20, the device 30, and the like, of the present disclosure, it is possible to appropriately adjust trade-off between jitter and latency.

Note that the electronic equipment 10 (for example, the electronic musical instrument 10, the same applies hereinafter) may include a reception unit (reception circuit, for example, the USB interface 107) that receives measurement data including identification number information and counter value information, and a transmission unit (for example, the USB interface 107) that transmits return data constituted by updating the counter value information of the measurement data on the basis of the number of times of reception of the measurement data. According to such a configuration, radio communication for the electronic equipment can be easily measured.

The reception unit may receive a plurality of pieces of the measurement data transmitted at a certain transmission interval (for example, 15 ms), and the transmission unit may transmit the return data for each of the plurality of pieces of the measurement data. According to such a configuration, it is possible to suitably measure the throughput, jitter, and the like, of the radio communication in a certain period.

Further, the measurement data may be a system exclusive message, a control change message, or an assignable controller message of musical instrument digital interface (MIDI). According to such a configuration, it is possible to implement measurement suitable for radio communication (for example, BLE-MIDI) between devices that can use the MIDI.

The reception unit may receive the measurement data via a dongle (dongle 20) physically connected to the electronic equipment 10, and the transmission unit may transmit the return data via the dongle. According to such a configuration, in a case where the electronic equipment 10 does not have a function of directly performing radio communication with the device 30, it is possible to implement measurement of radio communication between these via the dongle 20.

Note that the electronic equipment 10 may include: a reception unit that receives a musical instrument digital interface (MIDI) message, time stamp information (for example, the USB interface 107) regarding an execution timing of the MIDI message, and offset information regarding buffering of the MIDI message, and a control unit (processor, for example, the CPU 101) that controls the execution timing of the MIDI message according to the time stamp information on the basis of the offset information. According to such a configuration, it is possible to implement suitable adjustment of trade-off between jitter and latency for radio communication for an electronic equipment.

Further, the reception unit may receive the offset information included in a system exclusive message, a control change message, or an assignable controller message of the MIDI. According to such a configuration, it is possible to perform control suitable for radio communication (for example, BLE-MIDI) between equipment that can use the MIDI.

Further, the control unit may determine whether or not to control the execution timing by the time stamp information on the basis of the system exclusive message, the control change message, or the assignable controller message of the MIDI. According to such a configuration, it is possible to perform control suitable for radio communication (for example, BLE-MIDI) between equipment that can use the MIDI.

Furthermore, the reception unit may receive the time stamp information, the offset information, and the MIDI message via a dongle (dongle 20) physically connected to the electronic equipment 10. According to such a configuration, in a case where the electronic equipment 10 does not have a function of directly performing radio communication with the device 30, it is possible to suitably adjust trade-off between jitter and latency for radio communication between these via the dongle 20.

Each aspect/embodiment described in the present disclosure may be used alone, or may be used in combination, or may be switched in accordance with execution. In addition, the order of the processing procedure, sequence, flowchart, and the like, of each aspect/embodiment described in the present disclosure may be changed as long as there is no contradiction. For example, for the methods described in the present disclosure, elements of various steps are presented using an example order, and the order is not limited to the particular order presented.

As used in the present disclosure, the description “on the basis of” does not mean “based only on” unless explicitly stated otherwise. In other words, the description “on the basis of” means both “based only on” and “based at least on”.

Any reference to elements using designations such as “first”, “second”, and the like, as used in the present disclosure does not generally limit an amount or order of those elements. These designations may be used in the present disclosure as a convenient way to distinguish between two or more elements. Thus, reference to the first and second elements does not imply that only two elements may be employed or that the first element must in any way precede the second element.

In a case where the present disclosure uses the terms “include”, “including”, and variations thereof, these terms are intended to be inclusive in a manner similar to the term “comprising”. Furthermore, the term “or” used in the present disclosure is intended not to be an exclusive OR.

“A/B” in the present disclosure may mean “at least one of A or B”.

In the present disclosure, for example, in a case where articles such as a, an, and the in English are added by translation, the present disclosure may include a case where a noun following these articles is a plural form.

Although the invention according to the present disclosure has been described in detail above, it is apparent to those skilled in the art that the invention according to the present disclosure is not limited to the embodiments described in the present disclosure. The invention according to the present disclosure can be implemented as modifications and variations without departing from the spirit and scope of the invention defined on the basis of the description of the claims.

Thus, the description of the present disclosure is provided for the purpose of illustration and does not bring any restrictive meaning to the invention according to the present disclosure.

What is claimed is:

1. An electronic equipment comprising:
a reception circuit that receives a musical instrument digital interface (MIDI) message, time stamp information regarding an execution timing of the MIDI message, and offset information regarding buffering of the MIDI message; and
a processor that controls the execution timing of the MIDI message according to the time stamp information on a basis of the offset information.

2. The electronic equipment according to claim 1, wherein
the reception circuit receives the offset information included in any of a system exclusive message, a control change message, and an assignable controller message of MIDI.

3. The electronic equipment according to claim 1, wherein
the processor determines whether to control the execution timing according to the time stamp information on a basis of any one of a system exclusive message, a control change message, and an assignable controller message of MIDI.

4. The electronic equipment according to claim 1, wherein
the reception circuit receives the time stamp information, the offset information, and the MIDI message via a dongle physically connected to the electronic equipment.

5. A device comprising:
a processor that determines offset information for controlling an execution timing of a musical instrument digital interface (MIDI) message according to time stamp information; and
a transmission unit that transmits the timestamp information, the offset information, and the MIDI message.

6. A system comprising an electronic equipment and a device,
the electronic equipment including:
a reception circuit that receives a musical instrument digital interface (MIDI) message, time stamp information regarding an execution timing of the MIDI message, and offset information regarding buffering of the MIDI message; and
a processor that controls the execution timing of the MIDI message according to the time stamp information on a basis of the offset information, and
the device including:
a processor that determines the offset information; and
a transmission unit that transmits the timestamp information, the offset information, and the MIDI message.

7. A method of an electronic equipment comprising:
receiving a musical instrument digital interface (MIDI) message, timestamp information regarding an execution timing of the MIDI message, and offset information regarding buffering of the MIDI message; and
controlling the execution timing of the MIDI message according to the time stamp information on a basis of the offset information.

8. A non-transitory computer-readable recording medium storing a program that causes a computer of an electronic equipment to:
receive a musical instrument digital interface (MIDI) message, time stamp information regarding an execution timing of the MIDI message, and offset information regarding buffering of the MIDI message; and
control the execution timing of the MIDI message according to the time stamp information on a basis of the offset information.
